(19) United States
(12) Patent Application Publication
(10) Pub. No.: US 2002/0070528 A1
(43) Pub. Date: Jun. 13, 2002

(54) Recreational vehicle trailer

(76) Inventor: Louis Lee Wilson SR., Kershaw, SC (US)

Correspondence Address: BROWN ENTERPRISES, LLP, 1367 HWY 1 NORTH, CASSATT, SC, 29032, US

(21) Appl. No.: 09/734,381

(22) Filed: Dec. 11, 2000

(51) Int. Cl. B60P 3/10

(52) U.S. Cl. 280/414.1

(57) ABSTRACT

A tow trailer capable of carrying a vehicle and subsequent recreational vehicles. The trailer is made from common angle, channel, pipe and tube materials found in most hardware stores. The trailer is seated on a wheeled, fendered chassis, with rigid and flexible supports for easy on/off load and safety. The trailer allows the user the option of carrying a vehicle up to pick-up truck size on the lower level and a trailer with recreational vehicles on the top level. The top level lowers and raises to allow on/off load. The trailer has an inclusive braking and winching system to allow one person operation.

### FIELD OF INVENTION

This invention relates to a single chassis, tow capable trailer, and is specifically designed to carry a vehicle and a boat on it's trailer. The invention may also carry other recreational vehicles in lieu of the boat and trailer, but maintains the same vehicle carrying capability.

### BACKGROUND OF THE INVENTION

With the increase of travel in self propelled motor homes, a means is necessary to provide transportation for travelers at their final destination. Additionally many destinations are vacation spots where travelers can enjoy the use of a boat or other recreational vehicle. With conventional means of transport, the traveler must choose between a vehicle or recreational vehicle. While there have been trailers designed for dual purpose transportation, those proposed or designed do not allow the transportation of the recreational vehicle trailer as well. Most are mechanically difficult to handle, and require either modifications to the tow vehicle and/or special hardware for adaptation. This trailer allows the flexibility to transport either or both entities specified and requires no special equipment or handling.

### SUMMARY OF INVENTION

The present invention provides a dramatically simplified transport trailer for automobiles, boats on trailers and other recreational vehicles. This trailer is fabricated from common materials and well suited to towing by any tow capable vehicle. The trailer is constructed with braking and lighting accessories and a self contained wench system, which allows easy on-load and off-load capabilities. When the trailer is used to transport a boat on the trailer it allows the user the capability to further transport the boat and trailer to alternate locations away from the initial tow site. The ability to carry the secondary vehicle allows the user complete transportation flexibility at a final destination, without having to depend on the primary transportation mode, as in the case of a motor home.

### DESCRIPTION OF DRAWINGS

FIG. 1 Boat Loading Mode—is a view of the trailer in the boat loading mode, with pivot and cable system detailed.

FIG. 2 Traveling Mode (side view)—is a side view of the trailer constructed by the preferred embodiment, details the loading ramp and tongue.

FIG. 3 Traveling Mode (rear view)—is a rear view of trailer in the traveling mode, detailing the pulley and winch system and vehicle tie-down capability.

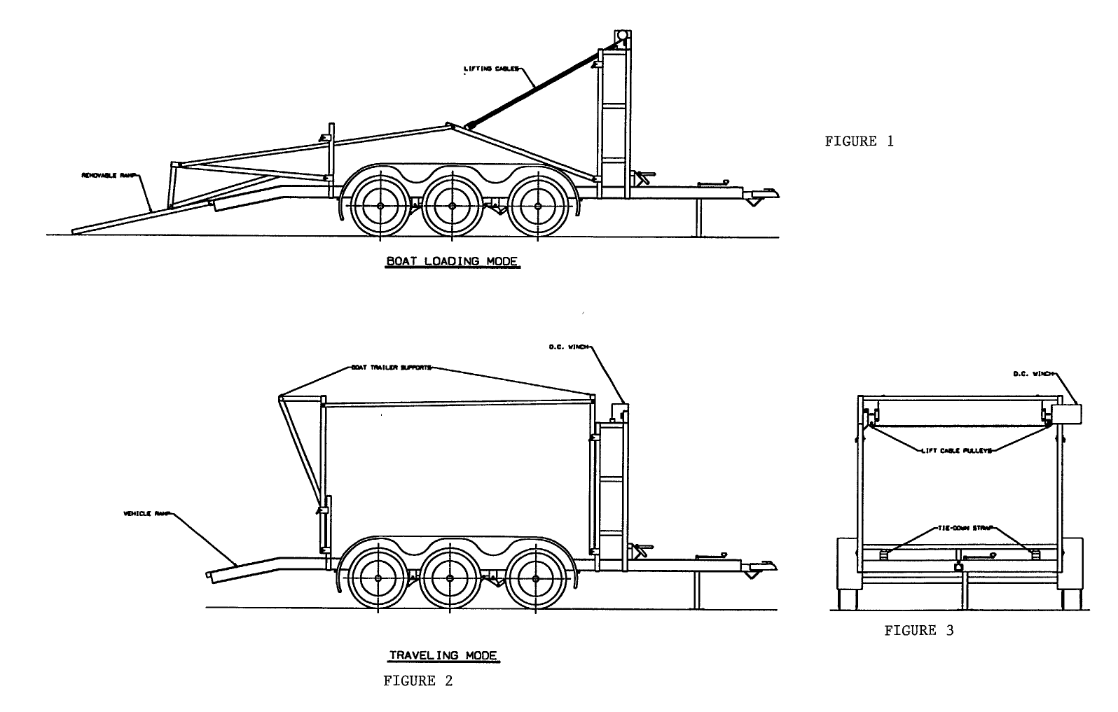

### DETAILED DESCRIPTION OF PREFERRED EMBODIMENT

The trailer is formed of various common materials and parts available in normal retail channels. Referring to the drawings, the trailer is a single constructed chassis, with dual layer capability.

The bottom of the chassis is constructed initially by placing 2 pieces of 5″channel, 20 ft long on a elevated flat surface 80″ apart. Measuring 8′6″ from the rear the center hanger is attached, this hanger will support the equalizer. 29″ centered on each side of the equalizer rigid hangers are affixed. On each piece of channel, 30″ from the rear, cut a wedge 1″ to 0″ in the bottom, this allows the channel to drop 5″. Equalizer and rigid hangers used are found in a standard wheel kit for 2″ round axles.

Install floor joists, comprised of 3″ channel, 4.1 wt. cut to 78 ⅜″ (7 each), place the 1st joist 15 ft from the rear of the trailer, then 30″ on center until complete. The 1st joist is not permanently affixed until after the tongue has been placed. Once joist #2-6 are affixed, install the tongue at the center of the second joist and cut 3″ from center joist and put in place, this anchors the tongue. Joist #1 is now affixed in place. All joists are flush with the bottom of the chassis. Top of joist #1 is 2×2×⅛ tube 78 ⅜″ with 3″2×2×⅛ tube 4″ long between floor plate, welded to front riser.

Add 2×2 angle across 1st joist, the remaining angle will be cut to fit the 20″ floor plate. Floor plate consists of previous joists and 2×2 angle. Add 2 pieces of 2×2 angles running the full length of the chassis to accommodate the 20″ floor plate. Channels are installed with the open to the back, to eliminate the accumulation of dirt and road grime from accumulating.

Over each joist, affix a support of 2×2 angle from chassis, inward to the floor plate. This completes the top level of the carrier.

Install the floor plate, 10′×20″ and 5′×20″ for 15 ft of floor bed. Tack weld on each side (1″ weld), to the chassis and 2″ angle.

Make 2 front rigid risers independently, for installation to the above chassis. Front risers are constructed of 2×2, ⅛″ tube, 65″×16″. On the riser to be used on the right side of the trailer install a base plate for the wench., the left riser will be constructed with a mount for the return pulley system.

Mount the front risers to the bottom of the chassis at the front of the floor plate. The riser is 60″ from the floor plate to the top of the riser after installation. On both risers a pivot hinge 6″ from the floor plate, on the rear side of the riser, then install lifting arms constructed of 2×2 tube cut 63″. On each lifting arm cut a ¾″ hole, 1″ from the bottom, rear section, install a ¾″-½″ metal bushing (nipple). This allows each arm to properly pivot.

The 2 rear risers are constructed of 2×2 tube with 1 ½ schedule 80 carbon pipe welded across top, welded on both ends. It is the same at front risers, ch. 40 pipe. Pivot points are cut with a ¾″ hole, 1″ from the bottom, rear section, and ¾″-½″ metal bushings (nipples) are installed. Latch keepers with locking pins are installed at the top, with a 1″ extension to each rear riser. Risers are then affixed, by weld to the outside of the chassis, flush with the bottom pivot hinge and equal to the front pivot hinge.

The axles, 35.5K round axles, 80″ spring center, with hubs, 5 on 4.5 are then attached to the chassis on the previously installed rigid hangers. 4 Leaf springs are used for stabilization. Tires mounted are TS205/75/14, 50 pound pressure, trailer service tires.

The section front of joist #1, which consists of the remainder of the chassis is then completed. Apply heat at front corner of the right channel of the floor plate and, with a pulling device, specifically a “come-along” apply pressure to the outer end of the channel and bring it in until it meets the tongue. This piece of channel is then welded to the tongue. Repeat this procedure with the left channel of the floor plate. Tongue will extend 8″ forward from the weld points of the channel. Install a 6,000 pound, 2″ ball hitch. The tongue jack is a top wind, 2000 pound capable

Loading ramps are constructed of 1 ½″ square tube and 2 each #9 raised expanded metal. Overall dimensions are 13″W, 60″L, install with adequate bracing for support.

The front right riser has 3″×¾″×½″ bore pulley assembly, side by side, conjoined. Cable goes through bottom pulley to the left riser where the pulley is mounted. Return through the top pulley to the winch, installed on the right riser.

Front and rear risers are connected by 1 ½″×3/16″ flat stock, hinged on each end, running vertically. Under each riser 3×4×¼″ weld supports are affixed for stability. Each riser has ¾″ pillow blocks, constructed on 8×11×¼″ flat pulley mechanism. Shaft for pillow block is ¾″ stock, 6 ½″ long.

Fenders are constructed and welded to the chassis a logical points and reinforced on each end. Fenders are 66″L, 10 ¾″W and 20″H, constructed of carbon metal, 16 gauge.

I claim:

1. A trailer for transporting a vehicle and a boat and trailer on a single chassis. Trailer is able to be towed by any tow capable vehicle.

2. Trailer is comprised of common use materials, 3″ and 5″ channel; 1 ½″ tube; ¼″ flat metal in various widths; pillow blocks; wheel & tires; stabilizing jacks; tongue jack; round stock; schedule 80 pipe; schedule 40 pipe; 2×2 angle; disk or drum brakes; 4500 LB electric wench; pulley system for raising and lowering; sheet metal ramps and fender

3. The trailer of claim 1 may carry a vehicle or truck, with a boat and trailer The trailer of claim 1 may carry a vehicle and trailer comprised of other recreational vehicles in lieu of a boat and trailer.
